(19) United States
(12) Patent Application Publication
(10) Pub. No.: US 2002/0191205 A1
(43) Pub. Date: Dec. 19, 2002

(54) Apparatus for selectively distributing document production job output

(76) Inventor: Gary G. Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/870,972

(22) Filed: May 31, 2001

(51) Int. Cl. G06F 3/12; G06K 15/02; G06F 13/00

(52) U.S. Cl. 358/1.13; 358/1.15

(57) ABSTRACT

A document production apparatus has a job output distribution control module for creating subsets of job output within a single executed document production job. The subsets may be created to contain numbers of documents as specified by a user. Additionally, the distribution control module directs the thus created subsets to deposit in desired output receptacles. Preferred embodiments of the document production apparatus comprise copiers and printers.

### FIELD OF THE INVENTION

The present invention is related to the field of document production apparatuses. More particularly, the present invention is related to apparatuses such as printers and copiers that selectively create subsets of output from a single document production job.

### BACKGROUND OF THE INVENTION

Many apparatuses exist for executing document production jobs. Often, these apparatuses are provided with designated receptacles for receiving the document production output. A job executed by the apparatus will result in documents being produced and deposited in a receptacle. By way of example, copiers may be provided with a plurality of output receptacles in the form of trays or bins, with output from different copy jobs being sent to different trays. In addition to copiers, printers may also be provided with a plurality of output trays or bins. In particular, networked printers that are shared by multiple users typically have multiple output trays. Each networked user directs the output from his print job to a desired tray or bin, or may even have an assigned output tray or bin. This allows the multiple users to easily separate and identify their output.

Some existing copiers and printers are capable of evenly distributing output from a job between a plurality of trays in a collated manner. That is, it is known to collate output copies to form multi-page documents by depositing a copy of a first page of a multi-page original document in each of a plurality of output receptacles. A copy of the second page of the original is then copied and deposited into each of the output receptacles. This process continues until a complete set of all the pages of the original document is in corresponding number of the output receptacles. Other collating methods are known. For example, it is known to produce collated output documents by depositing a complete multi-page document in a first output receptacle, depositing a second complete multi-page document in a second output receptacle, depositing a third complete document in a third receptacle, and so on, until the desired number of complete copies of the original have been produced.

The prior art also includes a number of patents broadly dealing with document delivery to trays of document production apparatuses. By way of example, U.S. Pat. No. 5,697,761 for “Mailbox Bin Job Set Extractor” assigned to Xerox Corp. describes a dynamic mailboxing unit for separating job output from different users for a shared printer. Published Japanese Application No. 08209674 (Publication No. 10053338 JP; applicant Fuji Xerox Corp.) for “Tray Selecting Device of Multi-Tray” describes multi-tray distribution of documents based on paper size. U.S. Pat. No. 5,982,510 for “Information Recording Device which Selects Paper Tray and Shifts Output According to Received Image Data or Source” assigned to Brother Kogyo Kabushiki Kaisha describes an apparatus for delivering produced documents to different output trays depending on what kind of information is recorded on the document. U.S. Pat. No. 4,466,608 for a “Movable Tray Sheet Sorter” assigned to Gradco Systems, Inc. describes an apparatus having a plurality of sorting bins for manually and individually sorting and collating output documents.

The teaching of these patents, as well as all other known document production apparatuses, however, leave many problems in the art unresolved. Many copier users, for instance, are faced with the task of creating unmatched sets of printed output, such as may be required for differing distribution sets. By way of example, a user may wish to distribute thirteen copies of an original to a first work group, four copies to a second work group, nine copies to a third work group, sixty seven copies to a fourth work group, and twenty one copies to a fifth work group. The only known method for accomplishing these results would be to execute separate copy jobs for each work group, or to execute one large copy job and then manually subdivide each of the respective work group copies in required numbers in subsequent steps. Executing separate copy jobs or manually separating an aggregate job is not practical when the required number of distribution sets becomes large.

Similar problems exist for printer users. While the printing of multiple copies has been limited in the past due to the generally higher cost of a printed page as compared to a photocopied page, technological advances have made the printing of multiple copies cost competitive to copying. The result is that many modern printer users utilize a printer to produce multiple copies of documents. At times, a user may wish to print differing numbers of copies for differing distribution. By way of example, a printer user may wish to print multiple documents for the above example distribution list: thirteen copies of an original to a first work group, four copies to a second work group, nine copies to a third work group, sixty seven copies to a fourth work group, and twenty one copies to a fifth work group. Presently known printers can achieve this result only by executing multiple print jobs, or by printing a single aggregate job and then manually dividing the output into the desired sets.

These and other problems remain heretofore unresolved in the art.

### SUMMARY OF THE INVENTION

The present invention is directed to an improved document production apparatus having a distribution control module for selectively creating a plurality of subsets of job output from execution of a single document production job. The distribution control module selectively directs each of the subsets to different output receptacles provided with the apparatus. Preferably, the number of documents to place in each of the output subsets and the destination output receptacle for each subset are specified by a user. Preferred embodiments of the document production apparatus of the invention comprise printers and copiers.

As will be appreciated by those knowledgeable in the art, the present invention also lends itself well to practice in the form of a computer program product. Accordingly, an additional embodiment of the present invention comprises a computer program product for selectively distributing the output of a copy job to a plurality of output receptacles in selected quantities.

Through practice of the invention, a user is advantageously able to execute a single document production job and to create output subsets having differing numbers of documents to be deposited in different output receptacles. By way of example, a user may within a single copy job create four output subsets to be deposited in four different trays. A first of the subsets may have five copies and be directed to a first tray, a second subset of six copies directed to a second tray, a third subset of seventy copies directed to a third tray, and a fourth subset of thirteen copies directed to a fourth tray.

The above brief description sets forth rather broadly the more important features and advantages of the present disclosure so that the detailed description that follows may be better understood, and so that the present contributions to the art may be better appreciated. There are, of course, additional features of the disclosure that will be described hereinafter that form the subject matter of the claims appended hereto. In this respect, before explaining the embodiment of the disclosure in detail, it is to be understood that the disclosure is not limited to the construction or arrangements set forth in the following description or in the drawings. The present invention may provide additional embodiments, as will be appreciated by those skilled in the art. Also, it is to be understood that the phraseology and terminology employed herein are for description and not limitation.

### BRIEF DESCRIPTION OF THE FIGURES

FIG. 1 is a schematic diagram of a copier embodiment of the apparatus of the invention.

FIG. 2 is a schematic diagram of a printer embodiment of the apparatus of the invention connected to a plurality of networked computers.

FIG. 3 is a flow chart illustrating a computer program embodiment of the invention.

### DETAILED DESCRIPTION

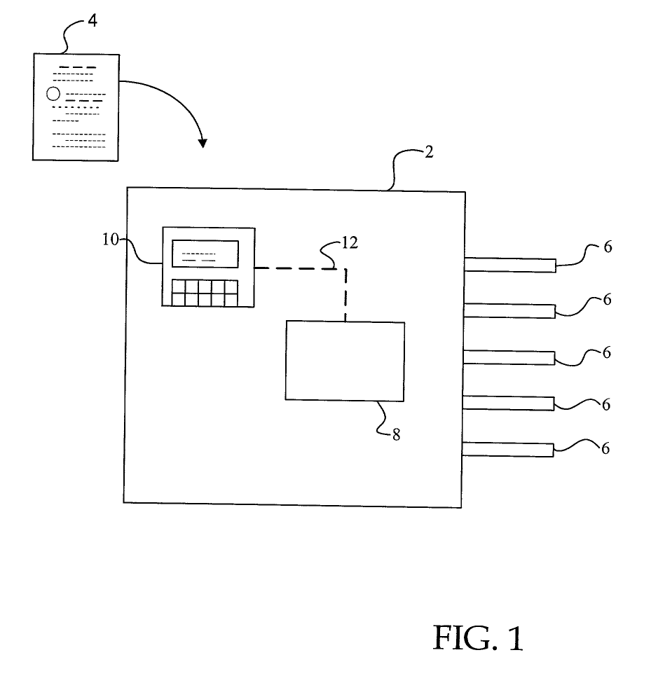

Turning now to the drawings, FIG. 1 is a schematic diagram of one copier apparatus embodiment of the invention. The copier 2 is for executing so called “copy jobs”, which comprise the reproduction of an image from an original document 4 onto a plurality of copies (not illustrated). The resultant plurality of copies is referred to herein as “copy job output”. That is, as used herein a “copy job” refers to a process of reproducing an image from at least one original document onto “copy job output” that comprises a plurality of documents each having a reproduction of the image. A copy job may comprise the reproduction of a document comprised of only a single page to produce a plurality of copies, or may comprise the copying of a multi-page document to produce a plurality of copies of the entire multi-page document.

The copier 2 is provided with a plurality of output receptacles for receiving the copy job output, with preferred receptacles comprising trays 6. It will be appreciated that output receptacles may comprise many different forms than the preferred trays 6. Indeed, it will be appreciated that as used herein the term “output receptacle” is intended to refer to a device for receiving copy job output. Other examples of output receptacles include, but are not limited to, bins, boxes, slots, shelves, virtual mailboxes or trays, and the like.

Importantly, the copier 2 also comprises an output distribution module 8. The output distribution module 8 is linked to a user accessible operating interface 10 provided with the copier, with the linkage 12 illustrated in FIG. 1 as a dashed line. The operating interface 10 is for at least partially controlling the copier 2, and preferably comprises at least a display and a plurality of selection means such as buttons or the like. The linkage 12 may comprise any number of functional connections for providing communication between the operating interface 10 and the distribution module 8, with examples including but not limited to wiring, circuitry embedded on a card or chip, wireless connection means, and the like. Also, it will be appreciated that the operating interface 10 may be external to the copier 2, and may for instance comprise a processor-based controller operating interface located remotely from the copier 2.

The distribution module 8 is for selectively creating a plurality of output subsets from execution of a single copy job, and for selectively directing the subsets to deposit in different trays 6. The number of copies to be placed in each of the output subsets is specified by the user through entry of a subset quantity selector value through the operating interface 10. Likewise, the particular tray 6 to direct each output subset can be specified through entry of a subset tray selector. Preferably, these selector values may be entered in a tabular or table format through the operating interface 10. It is noted that as used herein the terms “tray selector” and “receptacle selector” are intended to be synonymous.

The distribution module 8 has been illustrated in FIG. 1 as a “box”. In practice it will be appreciated that the module 8 may comprise any of several physical embodiments. By way of example, the distribution module 8 may comprise an electrical circuit for receiving instruction from the interface 10 and for causing mechanical paper handling means within the copier 2 to create and distribute the output subsets as instructed. The circuitry may be integrated circuitry on a medium such as a circuit board or card, chip or chipset, or the like.

By way of additional example, the copier 2 may be the type that comprises a processor, and the distribution module 8 may comprise processor executable instructions embedded in a processor-readable medium such as a magnetic, optical, or other memory device. The processor in the copier 2 may then execute those instructions upon reception of a prompt from the interface 10, with the result that the instructions cause mechanical paper handling means within the copier 2 to create and distribute the output subsets as instructed.

Additionally, it will be appreciated that the control module 8 may comprise a component of the copier 2, or may even comprise a subcomponent of a component of the copier 2. For example, the module 8 may comprise a subcomponent of the operating interface 10, or may comprise a subcomponent of a paper handling mechanism within the copier 2. Further, although illustrated as a single box, the control module 8 may comprise a plurality of individual functional components that may be physically separated from one another in the copier 2. A component of the control module 8, for instance, may comprise mechanical paper handling means within the “paper-handling engine” of the copier 2, with a second component comprising programmable instructions embedded in an operating interface memory module.

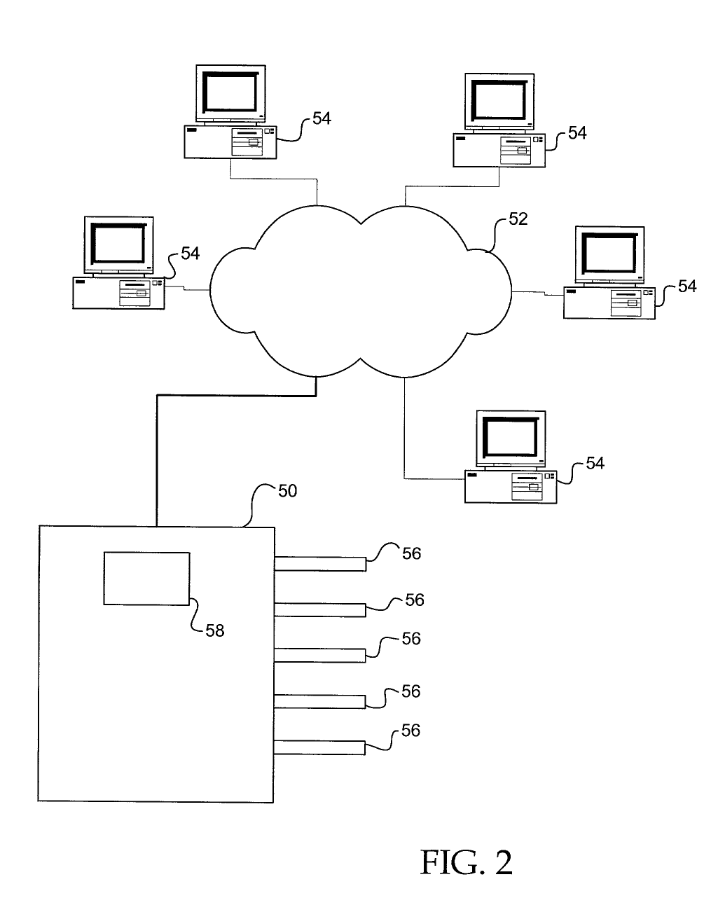

In addition to a copier, the document production apparatus of the invention may take the form of any of a number of additional embodiments. In particular, a second preferred embodiment comprises a printer. Accordingly, FIG. 2 illustrates a schematic of a printer 50 connected to a network 52, with a plurality of computers 54 connected to the network 52. The printer 50 comprises a plurality of output receptacles in the form of the preferred trays 56. It will be appreciated that a configuration as illustrated in FIG. 2 is of utility for sharing a printer between a plurality of users. In particular, each of the trays 56 preferably has a unique identifier associated with it that users from any of the computers 54 may use to direct print job output.

Unlike printers of the prior art, the printer 50 of the invention comprises a distribution control module 58 for selectively creating a plurality of job output subsets from a single print job, and for selectively directing the subsets to the output trays 56. The number of copies to be placed in each of the plurality of output subsets is determined by a user-specified subset quantity value. Likewise, the particular output tray 56 to direct each of the output subsets to is specified by a user-specified subset receptacle selection.

Thus, with the printer of the invention a user is able to execute a single print job and specify that a plurality of subsets be created within the print job output with each of the subsets comprised of a desired number of documents. Further, the user is able to specify which of the plurality of trays 56 each subset should be directed to.

The output distribution control module 58 has been illustrated in FIG. 2 as a “box” within the printer 50. As will be appreciated by those knowledgeable in the art, this representation of the control module 58 has been made for illustration purposes only. The output control module 58 in practice may comprise any of several embodiments, some of which reside in the printer 50, some of which reside elsewhere such as in any of the computers 54 or any other computer device that may be additionally connected to the network 52. Further, the control module 58 in practice may comprise a combination of some functional elements residing in the printer 50 and some in one or more of the computers 54. For example, a portion of the control module 58 may be a sub-component of a “printer engine”.

It is noted that conventional document handling “engines” for document production apparatuses such as printers, facsimile machines, and copiers are generally known in the art. In particular, those knowledgeable in the art will appreciate that a “document handling engine” may comprise processor controlled systems that respond to simple programmed commands and/or conventional electrical switch means to actuate cooperating gates, arms, fingers, motors, clutches, belts, rollers, solenoids, sensors, and the like. These document engine components work in combination to move sheets from a feeder supply, route the sheet along the sheet path into position for receiving an image thereon, and route the sheet to an output receptacle. Because document-handling engines as such are generally known, they are not discussed in detail herein. For additional disclosure, reference is made to U.S. Pat. No. 5,982,510 to Funahashi, herein incorporated by reference, which teaches one embodiment of a document-handling engine.

A preferred embodiment of the output control module 58 for use with a printer comprises a printer driver running on any of the computers 54 for functional interface between the computer 54 and the printer 50. In this preferred printer driver embodiment, the subset quantity selector and the subset receptacle selector values are entered through a graphic user interface (“GUI”) running on the computer 54. As used herein, the term GUI is intended to refer to an interface display shown on a screen that comprises a plurality of data fields for entry of data by a user.

Most preferably, a tabular or table interface is provided for entry of the respective subset quantity and receptacle values. As used herein, the terms “tabular” and “table” are intended to refer to an arrangement of columns and rows for data entry. It has been found that such a format provides for convenient and organized data entry with practice of the invention, particularly when a multiplicity of subsets is to be created and distributed. By way of example, Table 1 is an example table format that may comprise a portion of the preferred printer driver of the invention:

TABLE 1
Print Job Subset Distribution Selections

| Subset Tray Selector: | Subset Quantity Selector: |
|---|---|
| Tray 1 | 34 |
| Tray 2 | 65 |
| Tray 3 | 21 |
| Tray 4 | 5 |
| Tray 5 | 124 |

Thus, with the subset quantity selector and subset receptacle selector specified as above in TABLE 1, 34 copies within the copy job will be directed to the tray 56 identified as Tray 1, 65 copies within the copy job will be directed to Tray 2, 21 copies within the copy job will be directed to Tray 3, 5 copies to Tray 4, and 124 copies to Tray 5.

The number of subsets created will preferably correspond to the number of selector values that are input. That is, if a user enters three sets of subset quantity and tray selector values, three output sets will be created. Likewise, if a user enters one hundred sixty subset tray and quantity selector sets, one hundred sixty output sets will be created. Other means for determining how many output subsets to create could of course be provided within the invention. For example, an additional variable could be entered that comprised a total number of subsets to be created. It will be appreciated that there is no practical limit to the number of output subsets to create within practice of the invention, and that the number of subsets referred to herein is for purpose of example only.

In addition, it will be appreciated that a wide variety of tray identifiers may be used in addition to those described herein. Indeed, it may be most practical to identify trays or other receptacles with names associated with an ultimate destination for the output deposited therein. For example, trays may be identified by workgroups, such as Accounting, Administration, Human Resources, Engineering, and the like.

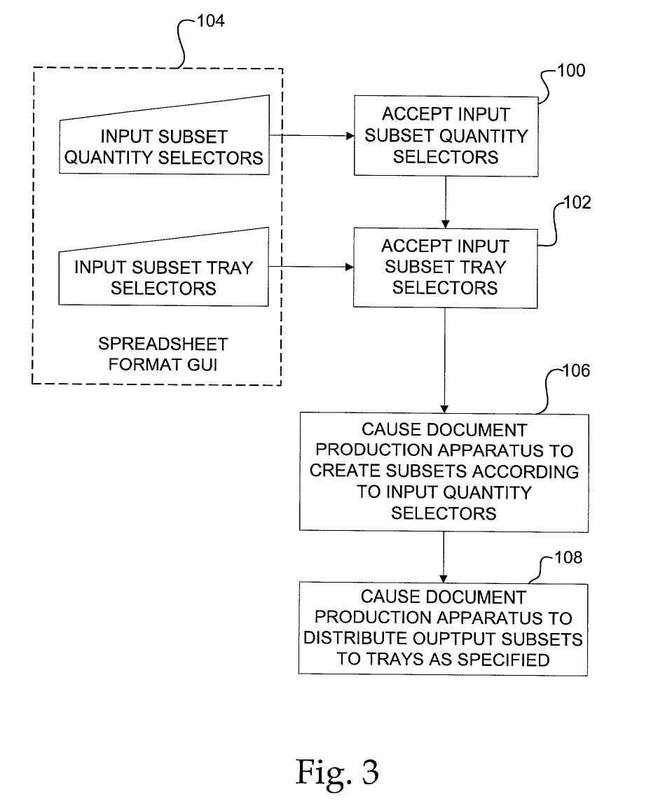

It will also be appreciated that the present invention lends itself well to practice in the form of a computer program product. Accordingly, an additional embodiment of the present invention comprises a computer program product for use with a document production apparatus, with the computer program product comprising computer executable instructions embedded in a computer readable medium. FIG. 3 is a flow chart illustrating one embodiment of the computer program product of the invention.

When executed the program instructions cause the apparatus to accept input subset quantity selections (100) and input subset receptacle selections (102). These selections are preferably input through a GUI in a table format (104). Individual selections may be input by typing of individual characters, or more preferably by choosing from a pre-defined set of choices by scrolling or the like. Each cell of a table, for instance, may have a scroll bar associated with it that allows for choosing from a number of pre-defined variable options.

The preferred GUI interface may be displayed for manipulation by a user in any of a number of manners and locations. If the document production apparatus comprises a printer, for example, a GUI interface may comprise an input/output screen displayed on a computer attached to the printer. The printer may be directly connected to the computer, or may be remotely connected via a network. Should the document production apparatus comprise a copier, the preferred GUI may comprise a display on an LCD or other screen comprising the copier-operating interface. The display screen and/or the operating interface may comprise switch means for entering data, such as scroll buttons, a keypad, a touch screen, or the like.

After accepting input selector values, the program instructions then cause the apparatus to create a plurality of output subsets from the execution of a single document production job (106). The subsets are created corresponding to the input selection values, so that a subset is created with the number of documents as specified by every one of the input quantity selections. By way of example, if three sets of input selector values were accepted with subset quantity values of 10, 25, and 35, then three corresponding output subsets would be created having 10, 25, and 35 documents therein. Likewise, the computer program product will cause the created output subsets to be distributed to output trays according to the tray selector values.

It will be appreciated that the computer program product embodiment of the invention may take any of several functional and/or physical forms. By way of example, the program product may comprise instructions for execution by a processor in a copier apparatus. In this case the instructions may be embedded in a memory module such as a magnetic or optical means in the copier, or external memory means to be input and read by the copier such as a portable disk. The program product may likewise be embedded on RAM, ROM, flash memory module, or the like in the copier. Additionally, the program instructions may comprise integrated circuitry on a chip or chipset in the copier.

Also, the computer program embodiment of the invention may take the form of a printer driver, or a component thereof, running on a computer attached to the document production apparatus. As used herein, the term “driver” is intended to refer to a computer program for functional interface with connected hardware. Most printers for use with computers require drivers, and some copy machines are connected to a computer that requires a driver for operation of the copier. It will be appreciated that the program product of the invention may be efficiently combined with existing drivers, as these programs may be required for using the apparatus and must therefore be obtained and loaded by apparatus users. No additional effort is thereby required to obtain and load the program product of the invention when it is combined with a driver.

When combined with an apparatus driver, the preferred GUI of the program product of the invention may comprise a screen within a plurality of apparatus set-up screens. By way of example, when using the Windows operating system from Microsoft Corp., Redmond, Wash., printing of documents from applications such as word processors with an installed printer allows for access to and manipulation of various printer “properties”. A user may be able to access a GUI printer menu that allows for adjustment of such items as type of paper, choice of printer, number of copies, quality of graphics, and the like.

A preferred computer program product embodiment will be accessible to the user through a part of such a GUI menu. An additional “tab” or similar selector on a “properties”, “printer” or similar menu may provide a table interface for entering numbers of output subsets, quantity of documents to place in respective subsets, and trays to output respective subsets to. Reference to Table 1 herein is made by way of example.

Using any of the various embodiments of the apparatus or program of the invention, users are able to execute a single document production job that results in the creation of a plurality of subsets within the production job, with the subsets able to be comprised of different numbers of copies. Additionally, the subsets can be distributed to different output receptacles for convenience of handling.

The various embodiments and examples described herein are representative of the known best modes of practicing the invention only, and should not be interpreted to limit the scope of the invention. Those skilled in the art will appreciate that many variations on the embodiments can easily be made within the scope of the invention as claimed. By way of example, although invention embodiments comprising a printer, a copier, and a program product have been described herein, it will be understood that the invention may take other embodiments including, but not limited to, document production apparatuses such as a facsimile (“fax”) machine, a scanner, combination printers/copiers/scanners and the like. By way of additional example, the sequence of program or apparatus operations may be easily changed from that described herein. Additionally, the apparatus of the invention may comprise any number of document production apparatuses in addition to a copier and printer as described.

By way of still further example, reference herein to “documents” is not intended to limit the practice of the present invention to paper. Indeed, as used herein the term “document” is intended to have its broadest possible interpretation, and may comprise virtually any medium capable of receiving a reproduced image thereon. Examples include, but are not limited to, papers; polyethylene, polycarbonate, polystyrene or other synthetic sheets; metal sheets, and the like.

What is claimed is:

1) An apparatus for executing a document production job to produce job output comprising documents, the apparatus having a plurality of output receptacles for receiving the job output documents, the apparatus comprising:
an output distribution module for selectively creating a plurality of job output subsets from execution of a single document production job and for selectively directing one of said plurality of output subsets to one of the plurality of output receptacles, wherein at least two of said plurality of job output subsets contain different numbers of output documents.

2) An apparatus for executing a document production job as defined by claim 1 wherein said output distribution module further comprises a subset quantity selector control for specifying a number of documents to place in each of said job output subsets.

3) An apparatus for executing a document production job as defined by claim 1 wherein each of the plurality of output receptacles has a unique identifier, and wherein said output distribution module further comprises a subset receptacle selector for selecting which of the plurality of output receptacles to direct each of said plurality of output subsets to.

4) An apparatus for executing a document production job as defined by claim 1 wherein the apparatus comprises a copier, and wherein the apparatus further comprises a user accessible control interface for at least partially controlling the copier, said control interface being linked to said output distribution module.

5) An apparatus for executing a document production job as defined by claim 4 wherein said control interface comprises at least a subset quantity selector for specifying a number of output documents to be placed in each of said plurality of job output subsets.

6) An apparatus for executing a document production job as defined by claim 4 wherein said control interface comprises at least a subset receptacle selector for selecting an output receptacle from the plurality of receptacles for directing each of said output subsets to.

7) An apparatus for executing a document production job as defined by claim 1 wherein the apparatus comprises a printer connected to at least one computer, and wherein at least a portion of said control module comprises program code for execution by the computer.

8) An apparatus for executing a document production job as defined by claim 7 wherein said control module further comprises a subset quantity selector for specifying a number of output documents from said single job to be placed in each of said output subsets and a subset receptacle selector for selecting which of the plurality of output receptacles to direct each of said plurality of output subsets to, said subset quantity selector and said subset receptacle selector accessible through the computer.

9) An apparatus for executing a document production job as defined by claim 7 wherein said distribution control module comprises a driver running on the computer, and wherein said distribution control module further comprises a subset quantity selector for selecting a quantity of documents to be placed in each of said output subsets, said subset quantity selector comprising a component of said driver accessible through a graphic user interface displayed on the computer.

10) An apparatus for executing a document production job as defined by claim 9, wherein said driver further comprises a subset receptacle selector for specifying which of the plurality of output receptacles to direct each of said plurality of output subsets to, and wherein said subset quantity selector and said subset receptacle selector are accessible through a table interface.

11) A copier for executing copy jobs, a copy job comprising generating job output comprising a plurality of documents, the copier being of the type that has a plurality of output receptacle trays each having a unique identifier, the copier comprising:
an output distribution control module for selectively creating a plurality of output subsets from the execution of a single copy job and for selectively directing each of said plurality of output subsets to one each of the plurality of output receptacles, at least two of said output subsets having different numbers of output documents therein; and,
a user accessible control interface for at least partially controlling the copier, said control interface linked to said output control module, said control interface having a subset quantity selector for specifying a number of copies to place in each of said plurality of output subsets, said control interface having a subset tray selector for selecting by unique identifier which of the plurality of output trays to direct each of said plurality of output subsets to.

12) A printer connected to at least one computer for executing print jobs, the printer having a plurality of output trays for receiving the printed documents, each of the trays having a unique identifier, the printer comprising:
a printer driver for execution by the computer for functional interface with the printer, the printer driver selectively causing the printer to create a plurality of subsets of output printed documents from a single print job and causing the computer to selectively deposit each of said output subsets in different output trays, said driver having a subset quantity selector for selecting a number of output documents to be placed in each of said plurality of output sets, at least two of said plurality of output sets having different numbers of documents, said driver having a subset tray selector for selecting by unique identifier which of the plurality of trays to direct each of said output subsets to, said printer driver accessible through a graphic user interface on the computer.

13) A printer as defined by claim 12 wherein at least a portion of said graphic user interface comprises a tabular interface for selecting values for said subset quantity selectors and for said subset tray selectors.

14) A computer program product for use with a document production apparatus, the apparatus for executing production jobs to produce job output, the apparatus being of the type that has a plurality of output receptacles for receiving the job output, the program product comprising computer executable instructions embedded in a computer readable medium, the instructions when executed causing the apparatus to:
accept a plurality of input subset quantity selections, each of said subset quantity selections comprising a number of documents to be placed in one each of a plurality of output subsets to be created from the execution of a single document production job, at least two of said subset quantity selections being different from one another;
create said plurality of output subsets from the execution of a single document production job, place a number of output documents corresponding to one of said plurality of subset quantity selections in one each of said output subsets; and,
direct one each of said plurality of output subsets to one each of the plurality of output receptacles.

15) A computer program product as defined by claim 14, wherein the computer program instructions when executed further cause the computer to:
accept a plurality of input subset tray selections, one each of said tray selections specifying which of the plurality of trays to direct one each of the plurality of output subsets to.

16) A computer program product for use with a printer, the printer for executing a print job to produce job output, the printer being connected to a computer and having a plurality of output trays, the computer program product comprising computer executable instructions embedded in a computer readable medium, the instructions when executed causing the printer to:
selectively create a plurality of job output subsets from the output of a single print job, each of said output subsets containing a number of documents specified by a user-input subset quantity selection, at least two of said subsets containing different numbers of documents from one another;
selectively direct one of said plurality of output subsets to one of the plurality of output receptacles as specified by a user-input subset tray selection; and,
wherein said user-input subset tray selections and said user-input subset quantity selections are made through a graphic user interface displayed on the computer.

18) A computer program product as defined by claim 17 wherein at least a portion of said graphic user interface comprises a tabular format for entering said subset tray selections and said subset quantity selections.

19) A computer program product for use with a copier, the copier for executing a copy job to produce job output, the copier having a user accessible control interface for at least partially controlling the copier, the copier being of the type that has an internal processor means, the computer program product comprising computer executable instructions embedded in a computer readable medium, the instructions when executed causing the copier to:
create a plurality of job output subsets from the execution of a single copy job, each of said output subsets containing a number of documents specified by a user-input subset quantity selection, at least two of said subsets containing different numbers of documents from one another;
direct each of said plurality of output subsets to one of the plurality of output receptacles as specified by a user-input subset tray selection; and,
wherein said user-input subset tray selections and said user-input subset quantity selections are made through the copier user interface.
